(19) United States
(12) Patent Application Publication
(10) Pub. No.: US 2024/0279963 A1
(43) Pub. Date: Aug. 22, 2024

(54) DRAWER GUIDE RAIL WITH INTERLOCKING FUNCTION

(71) Applicant: AODELI METAL PRODUCTS CO.,LTD, FOSHAN (CN)

(72) Inventor: YULIANG ZHAN, FOSHAN (CN)

(21) Appl. No.: 18/192,797

(22) Filed: Mar. 30, 2023

(30) Foreign Application Priority Data
Feb. 16, 2023 (CN) 202310129847.9

(51) Int. Cl. E05B 65/464

(52) U.S. Cl. CPC E05B 65/464

(57) ABSTRACT

The present application discloses a drawer guide rail with an interlocking function, and relates to the technical field of drawer guide rails. The drawer guide rail with interlocking function comprises a cabinet, at least three drawers arranged up and down on the cabinet, and a guide rail assembly arranged on an outer wall of each drawer. The guide rail assembly comprises an inner rail that drives the drawer to slide, an outer rail that is fixed on the cabinet, and a middle rail that connects the inner rail and the outer rail. The guide rail assembly is provided with an interlocking component with an interlocking function; The interlocking component comprises a fixing mechanism fixed on the outer rail, a toggle mechanism fixed on the inner rail, and at least one upper and lower interlocking linkage members inserted at one end of the fixing mechanism.

### CROSS-REFERENCE TO RELATED APPLICATIONS

This application claims the benefit and priority of Chinese Patent Application No. 202310129847.9, filed on Feb. 16, 2023, disclosure of which is hereby incorporated by reference in its entirety.

### TECHNICAL FIELD

The present application relates to the technical field of drawer guide rails, in particular to a drawer guide rail with interlocking function.

### BACKGROUND

At present, a plurality of drawers of articles such as traditional boxes, cabinets and tables are generally all controlled by one lockset. When the lockset is opened, all drawers are in a state to be opened, and each drawer can be opened and closed. Conversely, all drawers must be closed before locking. Patent application CN103206123A discloses an interlocking structure of a drawer, comprising a mounting plate, more than two interlocking pieces, more than three interlocking strips, a tension spring and a blocking piece, wherein an interlocking strip limiting piece is arranged on one side face of the mounting plate, the more than three interlocking strips are sequentially inserted in a gap formed between the interlocking strip limiting piece and the mounting plate in a propping manner, the blocking piece is fixedly connected with the mounting plate, the interlocking strip on the lowest end among the more than three interlocking strips is propped against the blocking piece, the interlocking strip on the uppermost end is connected with one end of the tension spring, the other end of the tension spring is connected with the mounting plate, each interlocking piece is hinged on the other side face of the mounting plate through a hinge shaft, a locking piece groove segment and an inserting segment bent inwards are arranged on the interlocking piece, a locking piece groove is arranged on the locking piece groove segment, a cambered limiting hole is formed in the mounting plate, and the inserting segment of the interlocking piece passes through the cambered limiting hole. According to the invention, only one drawer can be opened at one time, and the space of the original side rail of the drawer is utilized, so that the space occupation is small.

However, since the interlocking piece rotates along the hinge shaft, and each hinge shaft is independently installed on the mounting plate, it is easy to cause the hinge shaft and the interlocking piece to wear off or be damaged as the interlocking piece repeatedly moves for a long time, so that the interlocking piece gets stuck on the fixed piece, and finally the drawer cannot be opened. So we propose a drawer rail with interlocking function to solve the above problems.

### SUMMARY

Aiming at the deficiencies of the prior art, the present application provides a drawer guide rail with an interlocking function, wherein, through the structural cooperation of the guide rail assembly and the interlocking components, when drawers of the cabinet are closed, under the interlocking action of the interlocking components on the drawer, only one drawer can be pulled out at one time, which realizes the interlocking function between the guide rail assemblies, improves the structural stability and increases the safety and life of use, ensures the quality of the product

In order to achieve the above purpose, the application is achieved through the following technical solutions: A drawer guide rail with interlocking function comprising a cabinet, at least three drawers distributed up and down on the cabinet, and a guide rail assembly provided on an outer wall of each drawer, wherein the guide rail assembly comprises an inner rail that drives the drawer to slide, an outer rail fixed on the cabinet, and a middle rail connected the inner rail and the outer rail, wherein the guide rail assembly is provided with an interlocking component with an interlocking function;
the interlocking component comprises a fixing mechanism fixed on the outer rail, a toggle mechanism fixed on the inner rail, and at least one upper and lower interlocking linkage members inserted at one end of the fixing mechanism;
a sliding mechanism is slidably connected on surface of the fixing mechanism, and a transmission mechanism is arranged between the sliding mechanism and the fixing mechanism, and the transmission mechanism is movably connected with the sliding mechanism and the fixing mechanism on both sides, and the transmission mechanism is configured to slide on the fixing mechanism and the sliding mechanism;
the interlocking linkage member comprises a connecting rod and a plugging mechanism arranged at both ends of the connecting rod, and the plugging mechanism is configured to plug a top part or bottom part at one end of the fixing mechanism.

Further, the fixing mechanism comprises a fixing seat fixed on the outer rail, a surface of the fixing seat is provided with a first sliding groove, and a ferrule for insertion by the plugging mechanism is fixedly arranged on a top part and bottom part on the surface of the fixing seat.

Further, the sliding mechanism comprises a sliding plate slidably installed on the fixed seat, a surface of the sliding plate is provided with a shaft hole and a second sliding groove, and the shaft hole is located above the second sliding groove.

Further, the transmission mechanism comprises a movable block, a top part of outer wall surface of the movable block is provided with a shaft for inserting into the shaft hole, and a bottom part of the outer wall of the movable block is provided with a synchronous rod, and one end of the synchronous rod is slidably connected to an inner cavity of the first sliding groove, and the other end is movably connected to the second sliding groove.

Further, the toggle mechanism comprises a toggling plate fixed on an inner wall of the inner rail, a third sliding groove is provided on a surface of the toggling plate, and one end of the third sliding groove is in an open shape, and the third sliding groove is configured to movably engage the synchronization rod.

Further, the plugging mechanism comprises a latch plate fixed on the connecting rod, the other end of the latch plate is provided with a pull hook, and a blocking frame for blocking the movement of the sliding mechanism is arranged in the middle of a surface of the latch plate.

Further, the fixing seat is fixedly connected with the outer rail (302) through first rivets on both sides.

Further, a buffer elastic pieces are fixedly arranged at the upper and lower positions of one end of the fixing seat, and the upper and lower positions are located on the side where the ferrule is located, wherein the buffer elastic piece is configured to reduce the impact of the middle rail on the fixing seat.

Further, a reinforcement rod is provided on a surface of the toggling plate, wherein the reinforcement rod is located on the side where the third sliding groove is located, and the reinforcement rod is configured to strengthen a structural strength at the third sliding groove on the toggling plate.

Further, the toggling plate is fixedly connected with the inner wall of the inner rail through second rivets.

The present application has the following beneficial effects:

In the drawer guide with interlocking function, when all the drawers of the cabinet are closed, the interlocking linkage members can move up and down, and any drawer can be opened at this time. When a drawer of the cabinet is opened, the interlocking linkage members cannot move up and down. The plugging mechanism connected with the connecting rod in the interlocking linkage member blocks the sliding mechanism, so that the sliding mechanism cannot slide left and right. Simultaneously, the inner rail connected to the sliding mechanism cannot be pulled out, so that the all drawers cannot be opened.

The interlocking function of the drawer is realized through the mutual cooperation of the interlocking component and the guide rail assembly. The opening and closing action of each drawer drives the toggling plate in the toggle mechanism on the inner rail to move, so that the toggling plate and the synchronous rod in the transmission mechanism can interlock with each other. When the inner rail executes the opening and closing action, the third sliding groove on the toggling plate will push the synchronization rod on the movable block to move forward and backward. Since the shaft rod and the synchronous rod on the movable block are respectively plugged into the shaft hole and the second sliding groove on the sliding plate in the sliding mechanism, and the synchronous rod can slide along the second sliding groove, thereby forming mutual linkage, therefore, when the movable block moves back and forth, the sliding plate can be driven forward and backward through the synchronous rod and the second sliding groove. When the sliding plate is closed, the sliding plate is disengaged from the stop frame on the plugging mechanism, so that the plugging mechanism and the connecting rod can move up and down. At this time, any other drawer can be pulled out. On the contrary, when the sliding plate in the sliding mechanism is pulled out, one end of the sliding plate will withstand the stop frame in the plugging mechanism so that it cannot move up and down. When any one of the plugging mechanisms in the drawer is locked, the other drawers are locked at the same time through the interlocking cooperation between the plugging mechanism and the connecting rod so that other drawers cannot be opened.

When the synchronous rod in the transmission mechanism is at the upper end of the first sliding groove, the sliding plate in the sliding mechanism cannot move at this moment, and it is necessary to rely on the toggling plate in the toggle mechanism to push the synchronous rod to move. Therefore, the opening and closing action of the drawer drives the toggling plate and the synchronous rod to interlock with each other. When the inner rail performs the opening and closing action, the toggling plate will push the synchronization rod to move back and forth along the first sliding groove on the fixing seat.

Of course, any product for implementing the present application does not necessarily need to achieve all the above-mentioned advantages at the same time.

### BRIEF DESCRIPTION OF DRAWINGS

FIG. 1 is a structural diagram of the drawer of the present application in a closed state;

FIG. 2 is a structural diagram of the drawer of the present application in an open state;

FIG. 3 is a schematic diagram of the drawer of the present application in an assembled state;

FIG. 4 is an explosion diagram of the interlocking component of the present application;

FIG. 5 is a structural diagram of the installation of the fixing mechanism, the sliding mechanism, the transmission mechanism and the outer rail of the present application;

FIG. 6 is a schematic structural diagram of the installation of the toggle mechanism and the inner rail of the present application;

FIG. 7 is a schematic structural diagram of the fixing mechanism of the present application;

FIG. 8 is a schematic structural diagram of the sliding mechanism of the present application;

FIG. 9 is a structural schematic diagram of the transmission mechanism of the present application;

FIG. 10 is a schematic structural diagram of the toggle mechanism of the present application;

FIG. 11 is a schematic structural diagram of the plugging mechanism of the present application;

FIG. 12 is a schematic structural diagram of the interlocking linkage member of the present application;

FIG. 13 is a schematic structural diagram of the sliding mechanism driving the transmission mechanism to move backward;

FIG. 14 is a schematic structural diagram of the toggle mechanism engaging transmission mechanism of the present application;

FIG. 15 is a schematic diagram of the sliding mechanism of the present application;

FIG. 16 is a schematic diagram of the interlocking structure of the toggle mechanism and the transmission mechanism of the present application.

### REFERENCE SIGNS

1. Cabinet; 2. Drawer; 3. Guide rail assembly; 301. Inner rail; 302. Outer rail; 303. Middle rail; 4. Fixing mechanism; 401. Fixing seat; 402. First sliding groove; 403. Ferrule; 404. Buffer elastic piece; 5. Sliding mechanism; 501. Sliding plate; 502. Shaft hole; 503. Second sliding groove; 6. Transmission mechanism; 601. Movable block; 602. Shaft rod; 603. Synchronous rod; 7. Toggle mechanism; 701. Toggling plate; 702. Third sliding groove; 703. Reinforcement rod; 8. Plugging mechanism; 801. Latch plate; 802. Pull hook; 803. Stop frame; 9. Connecting rod; 10. First rivet; 11. Second rivet.

### DETAILED DESCRIPTION

The technical solutions in the embodiments of the present application will be clearly and completely described below in conjunction with the drawings in the embodiments of the present application. Apparently, the described embodiments are only some of the embodiments of this application, not all of them. Based on the embodiments in this application, all other embodiments obtained by persons of ordinary skill in the art without making creative efforts belong to the scope of protection of this application.

In the description of the present application, it should be understood that the terms “opening”, “upper”, “lower”, “thickness”, “top”, “middle”, “length”, “inner”, “surrounding” etc. Indicating orientation or positional relationship is only for the convenience of describing the application and simplifying the description, and does not indicate or imply that the components or elements referred to must have a specific orientation, be constructed and operated in a specific orientation, and therefore cannot be construed as limiting the application.

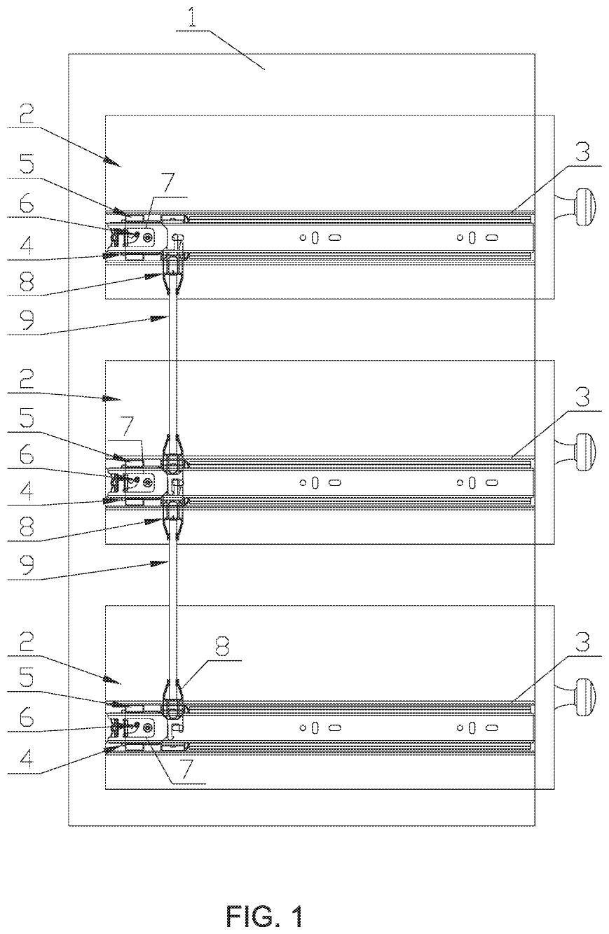

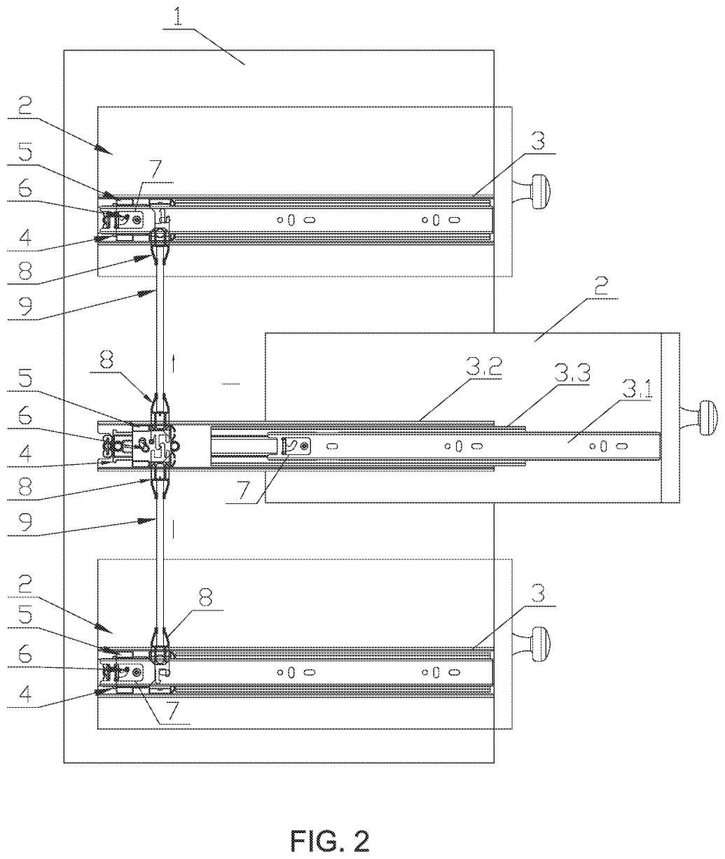

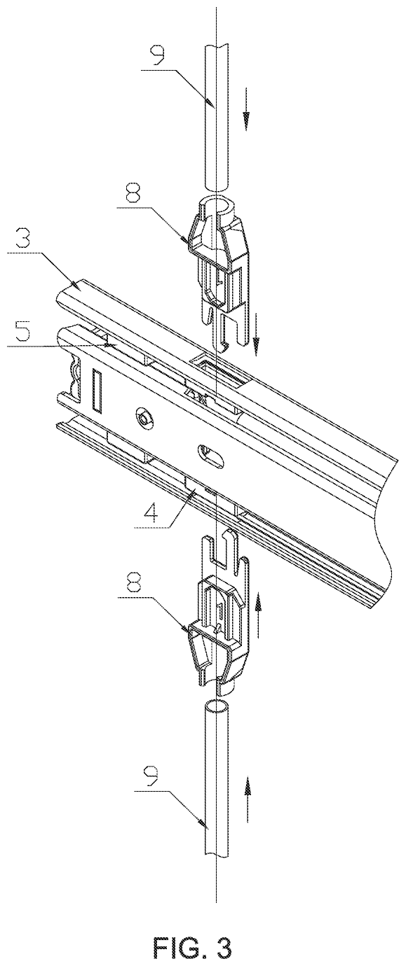

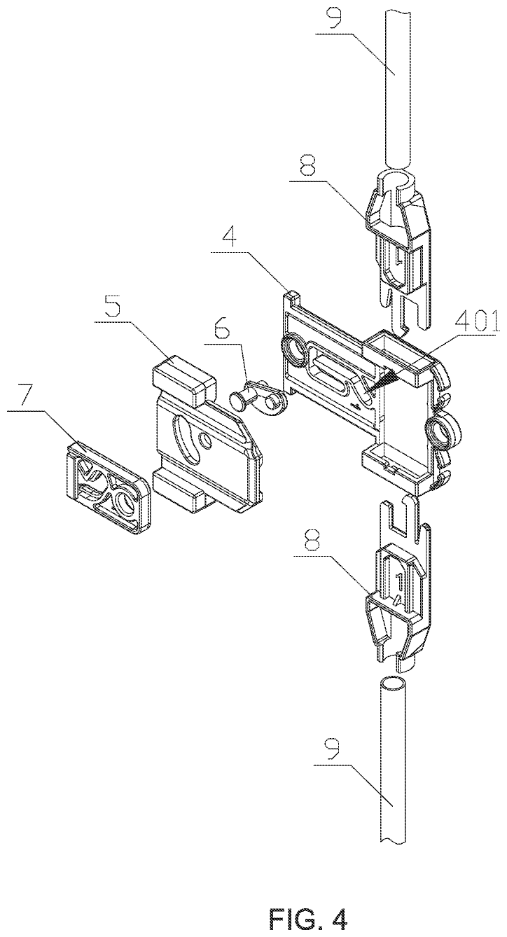

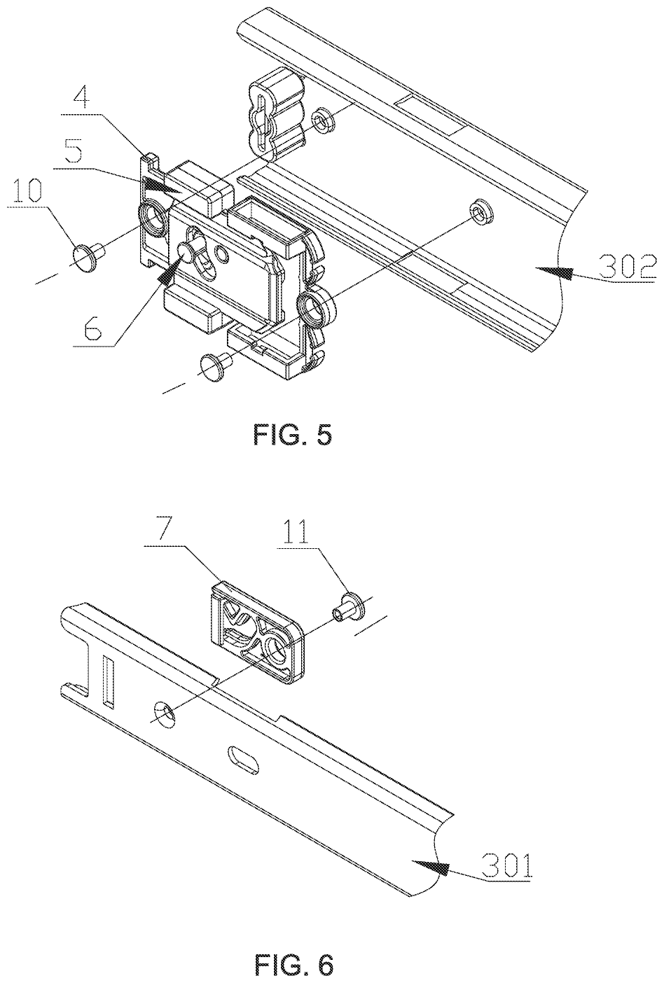

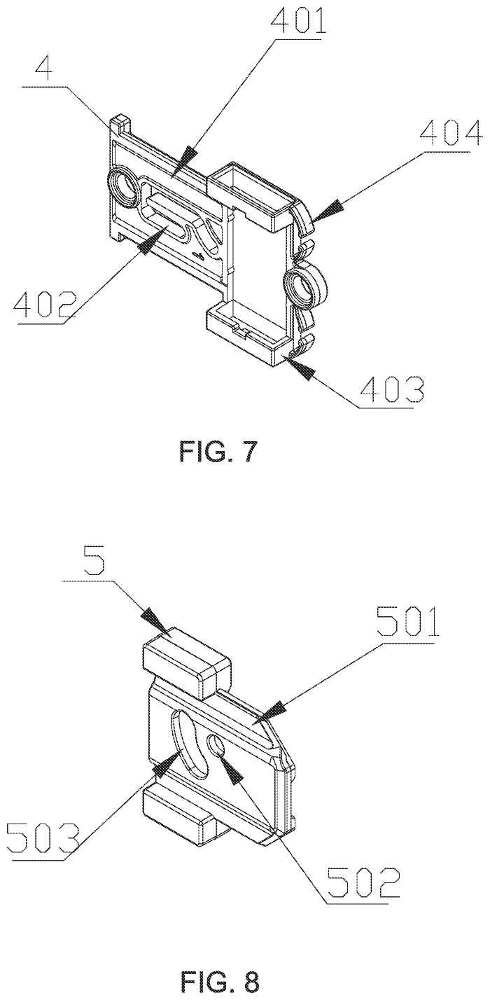

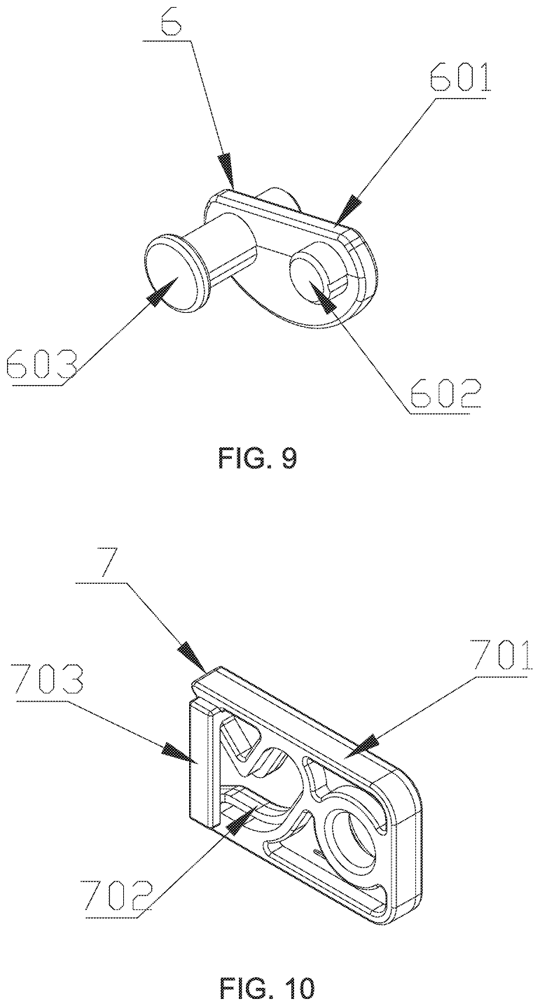

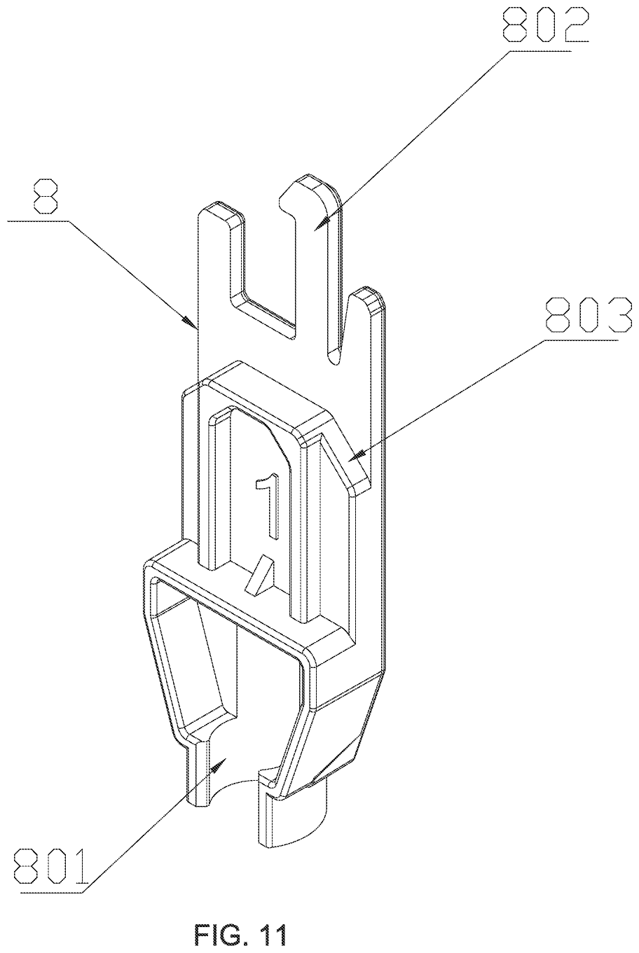

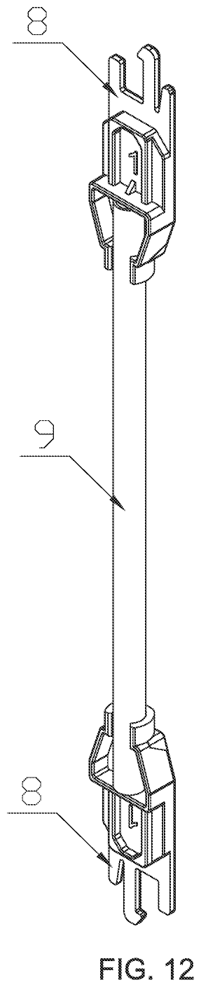

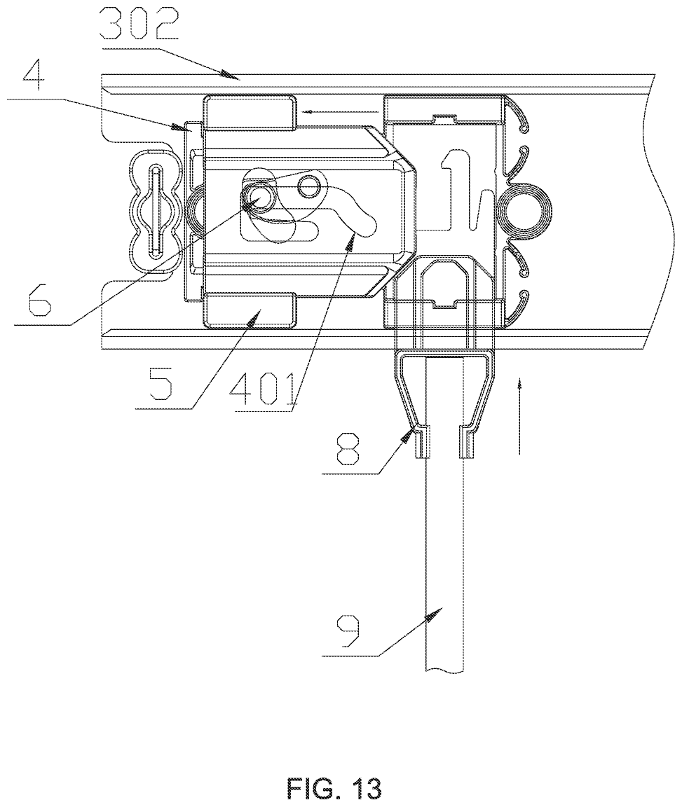

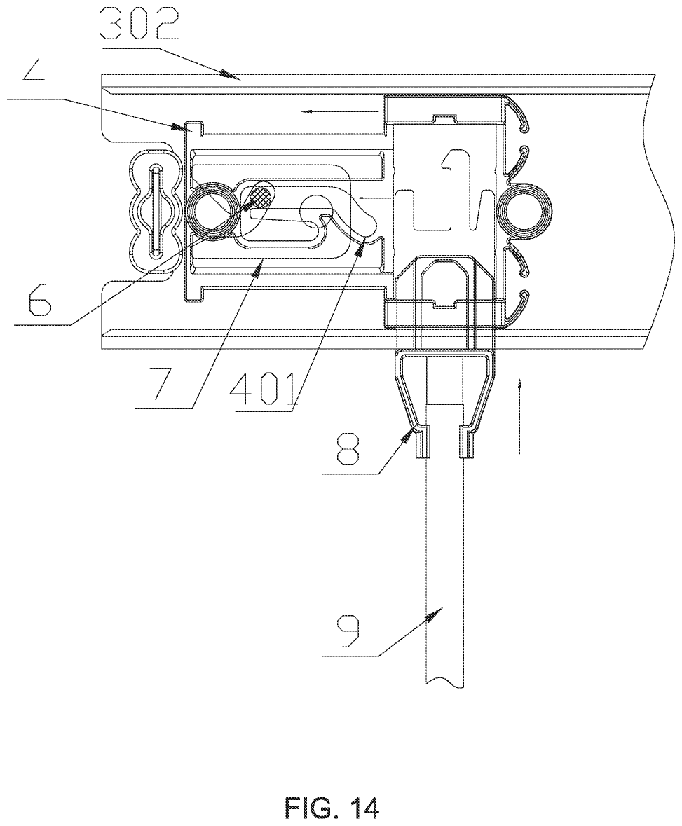

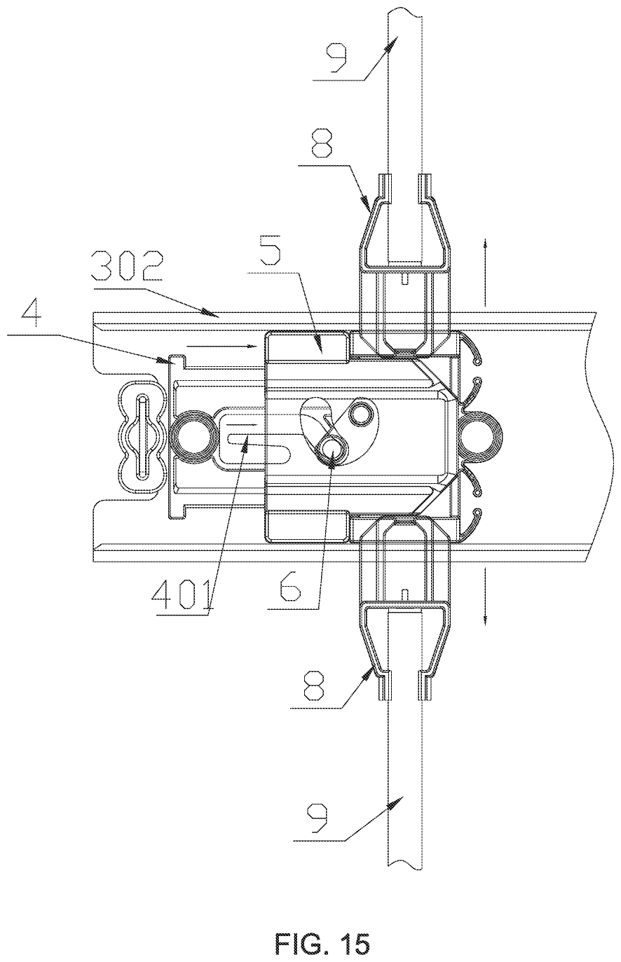

Please refer to FIG. 1-FIG. 16, the embodiment of this application provides a technical solution: A drawer guide rail with interlocking function comprising a cabinet 1, at least three drawers 2 distributed up and down on the cabinet 1, and a guide rail assembly 3 provided on an outer wall of each drawer 2, wherein the guide rail assembly 3 comprises an inner rail 301 that drives the drawer 2 to slide, an outer rail 302 fixed on the cabinet 1, and a middle rail 303 connected the inner rail 301 and the outer rail 302, wherein the guide rail assembly 2 is provided with an interlocking component with an interlocking function.

The interlocking component comprises a fixing mechanism 4 fixed on the outer rail 302, a toggle mechanism 7 fixed on the inner rail 301, and at least one upper and lower interlocking linkage members inserted at one end of the fixing mechanism 4.

A sliding mechanism 5 is slidably connected on surface of the fixing mechanism 4, and a transmission mechanism 6 is arranged between the sliding mechanism 5 and the fixing mechanism 4, and the transmission mechanism 6 is movably connected with the sliding mechanism 5 and the fixing mechanism 4 on both sides, and the transmission mechanism 6 is configured to slide on the fixing mechanism 4 and the sliding mechanism 6.

The interlocking linkage member comprises a connecting rod 9 and a plugging mechanism 8 arranged at both ends of the connecting rod 9, and the plugging mechanism 8 is configured to plug a top part or bottom part at one end of the fixing mechanism 4.
when all the drawers 2 of the cabinet 1 are closed, the interlocking linkage members can move up and down, and any drawer can be opened at this time. When a drawer 2 of the cabinet 1 is opened, the interlocking linkage members cannot move up and down. The plugging mechanism 8 connected with the connecting rod 9 in the interlocking linkage member blocks the sliding mechanism 5, so that the sliding mechanism 5 cannot slide left and right. Simultaneously, the inner rail 301 connected to the sliding mechanism 5 cannot be pulled out, so that the all drawers 2 cannot be opened.

The interlocking function of the drawer 2 is realized through the mutual cooperation of the interlocking component and the guide rail assembly 3. The opening and closing action of each drawer 2 drives toggle mechanism 7 on the inner rail 301 to move, so that the toggle mechanism 7 and the transmission mechanism 6 can interlock with each other. When the inner rail 301 executes the opening and closing action, the toggle mechanism 7 will push the transmission mechanism 6 to move forward and backward, the transmission mechanism 6 and the sliding mechanism 5 are interlock with each other. When the transmission mechanism 6 moves back and forth, the sliding mechanism 5 is driven to move back and forth simultaneously. When the sliding mechanism 5 is closed, the sliding mechanism 5 is disengaged from the plugging mechanism 8, and the plugging mechanism 8 and the connecting rod 9 can move up and down, and now other drawers 2 could be pulled out of any one. On the contrary, when the sliding mechanism 5 is pulled apart, the sliding mechanism 5 bears against the plugging mechanism 8 so that it cannot move up and down. When the plugging mechanism 8 of any one of the drawers 2 is locked, other drawers 2 are locked simultaneously through the interlocking cooperation between the plugging mechanism 8 and the connecting rod 9, so that other drawers 2 cannot be pulled out.

When the transmission mechanism 6 is at the upper end of the fixing mechanism 4, the sliding mechanism 5 cannot move at this moment, and it is necessary to rely on the toggle mechanism 7 to push the transmission mechanism 6 to move. Therefore, the opening and closing action of the drawer 2 drives the toggle mechanism 7 and the transmission mechanism 6 to interact with each other. When the inner rail 301 performs the opening and closing action, the toggle mechanism 7 will push the transmission mechanism 6 to move back and forth along the fixing mechanism 4.

Specifically, the fixing mechanism 4 comprises a fixing seat 401 fixed on the outer rail 302, a surface of the fixing seat 401 is provided with a first sliding groove 402, and a ferrule 403 for insertion by the plugging mechanism 8 is fixedly arranged on a top part and bottom part on the surface of the fixing seat 401.

In this embodiment, through the fixing seat 401 in the fixing mechanism 4, the stable fixing on it can be realized, and the opening space can be provided for the first sliding groove 402, so that the transmission mechanism 6 can be movably installed through the first sliding groove 402. Then the plugging mechanism 8 on the interlocking linkage member can be inserted into the ferrule 403, so that the plugging mechanism 8 can move up and down smoothly.

Specifically, the sliding mechanism 5 comprises a sliding plate 501 slidably installed on the fixed seat 401, a surface of the sliding plate 501 is provided with a shaft hole 502 and a second sliding groove 503, and the shaft hole 502 is located above the second sliding groove 503; the transmission mechanism 6 comprises a movable block 601, a top part of outer wall surface of the movable block 601 is provided with a shaft 602 for inserting into the shaft hole 502, and a bottom part of the outer wall of the movable block 601 is provided with a synchronous rod 603, and one end of the synchronous rod 603 is slidably connected to an inner cavity of the first sliding groove 402, and the other end is movably connected to the second sliding groove 503.

In this embodiment, through the sliding plate 501 in the sliding mechanism 5, it can not only slide left and right on the fixing seat 401, but also realize the installation of the shaft rod 602 and the synchronization rod 603 on the transmission mechanism 6 through the shaft hole 502 and the second sliding groove 503. Then the movable block 601 can take the shaft rod 602 as the axis, so that the synchronization rod 603 can slide in the second sliding groove 503 and the first sliding groove 402.

Specifically, the toggle mechanism 7 comprises a toggling plate 701 fixed on an inner wall of the inner rail 301, a third sliding groove 702 is provided on a surface of the toggling plate 701, and one end of the third sliding groove 702 is in an open shape, and the third sliding groove 702 is configured to movably engage the synchronization rod 603.

In this embodiment, through the toggling plate 701 in the toggle mechanism 7, it can not only be fixed on the inner wall of the inner rail 301, but also provide a space for the third sliding groove 702. Then the third sliding groove 702 can be flexibly clamped on the synchronization rod 603 while the inner rail 301 moves left and right, and then the position of the synchronization rod 603 can be adjusted.

Specifically, the plugging mechanism 8 comprises a latch plate 801 fixed on the connecting rod 9, the other end of the latch plate 801 is provided with a pull hook 802, and a blocking frame 803 for blocking the movement of the sliding mechanism 5 is arranged in the middle of a surface of the latch plate 801.

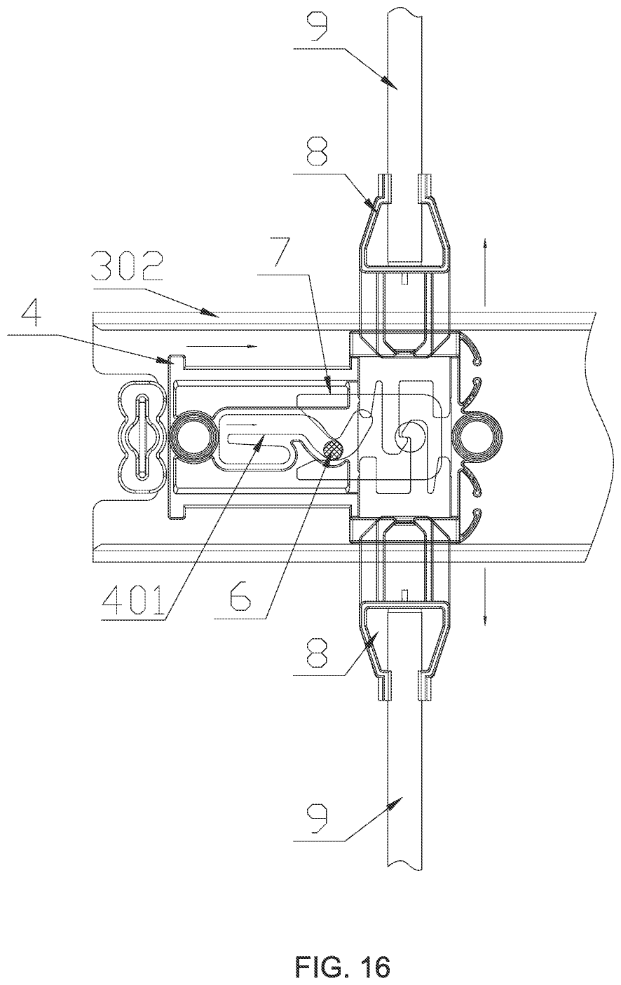

In this embodiment, through the latch plate 801 in the plugging mechanism 8, it can not only be fixed on the connecting rod 9, but also realize the installation of the pull hook 802 and the stop frame 803. Then, through the plugging mechanism 8 on the upper and lower interlocking linkage members, they can be snapped together as shown in FIG. 16. This not only enables the two interlocking linkage members to be plugged together, but also prevents them from being separated, thereby limiting the range of the interlocking linkage members moving up and down, and ensuring the stability of the interlocking linkage members in use.

Specifically, the fixing seat 401 is fixedly connected with the outer rail 302 through first rivets 10 on both sides.

In this embodiment, the fixing seat 401 can be fixed on the outer rail 302 through the first rivet 10.

Specifically, a buffer elastic pieces 404 are fixedly arranged at the upper and lower positions of one end of the fixing seat 401, and the upper and lower positions are located on the side where the ferrule is located, wherein the buffer elastic piece 404 is configured to reduce the impact of the middle rail 303 on the fixing seat 401.

In this embodiment, the impact of the middle rail 303 on the fixing seat 401 can be reduced by the buffer elastic piece 404.

Specifically, a reinforcement rod 703 is provided on a surface of the toggling plate 701, wherein the reinforcement rod is located on the side where the third sliding groove 702 is located, and the reinforcement rod 703 is configured to strengthen a structural strength at the third sliding groove 702 on the toggling plate 701.

In this embodiment, the structural strength at the third sliding groove 702 on the toggling plate 701 can be enhanced through the reinforcement rod 703.

Specifically, the toggling plate 701 is fixedly connected with the inner wall of the inner rail 301 through second rivets 11.

In this embodiment, the toggling plate 701 can be fixed to the inner wall of the inner rail 301 through the second rivet 11, which improves the stability of the toggling plate 701 in use.

When in use, when all the drawers 2 of the cabinet 1 are closed, the interlocking linkage members can move up and down, and any drawer 2 can be opened at this time. When a drawer 2 of the cabinet 1 is opened, the interlocking linkage members cannot move up and down. The plugging mechanism 8 connected with the connecting rod 9 in the interlocking linkage member blocks the sliding mechanism 5, so that the sliding mechanism 5 cannot slide left and right. Simultaneously, the inner rail 301 connected to the sliding mechanism 5 cannot be pulled out, so that all drawers 2 cannot be opened.

The interlocking function of the drawer 2 is realized through the mutual cooperation of the interlocking component and the guide rail assembly 3. The opening and closing action of each drawer 2 drives the toggling plate 701 in the toggle mechanism 7 on the inner rail 301 to move, so that the toggling plate 701 and the synchronous rod 603 in the transmission mechanism 6 can interlock with each other. When the inner rail 301 executes the opening and closing action, the third sliding groove 702 on the toggling plate 701 will push the synchronization rod 603 on the movable block 601 to move forward and backward. Since the shaft rod 602 and the synchronous rod 603 on the movable block 601 are respectively plugged into the shaft hole 502 and the second sliding groove 503 on the sliding plate 501 in the sliding mechanism 5, and the synchronous rod 603 can slide along the second sliding groove 503, thereby forming mutual linkage, therefore, when the movable block 601 moves back and forth, the sliding plate 501 can be driven forward and backward through the synchronous rod 603 and the second sliding groove 503. When the sliding plate 501 is closed, the sliding plate 501 is disengaged from the stop frame 803 on the plugging mechanism 8, so that the plugging mechanism 8 and the connecting rod 9 can move up and down. At this time, any other drawer 2 can be pulled out. On the contrary, when the sliding plate 501 in the sliding mechanism 5 is pulled out, one end of the sliding plate 501 will withstand the stop frame 803 in the plugging mechanism 8 so that it cannot move up and down. When any one of the plugging mechanisms 8 in the drawers 2 is locked, the other drawers 2 are locked at the same time through the interlocking cooperation between the plugging mechanism 8 and the connecting rod 9 so that other drawers 2 cannot be opened.

When the synchronous rod 603 in the transmission mechanism 6 is at the upper end of the first sliding groove 402, the sliding plate 501 in the sliding mechanism 5 cannot move at this moment, and it is necessary to rely on the toggling plate 701 in the toggle mechanism 7 to push the synchronous rod 603 to move. Therefore, the opening and closing action of the drawer 2 drives the toggling plate 701 and the synchronous rod 603 to interlock with each other. When the inner rail 301 performs the opening and closing action, the toggling plate 701 will push the synchronization rod 603 to move back and forth along the first sliding groove 402 on the fixing seat 401.

It should be noted that in this application, relational terms such as first and second are only used to distinguish one entity or operation from another entity or operation, and do not necessarily require or imply that there is a relationship between these entities or operations. There is no such actual relationship or order between them. Furthermore, the term “comprises”, “comprises” or any other variation thereof is intended to cover a non-exclusive inclusion such that a process, method, article, or apparatus comprises not only those elements, but also comprises also other elements not expressly listed or inherent in such a process, method, article, or device.

The preferred embodiments of the present application disclosed above are only used to help clarify the present application. The preferred embodiments are not exhaustive in all detail, nor is this application limited to specific implementations. Obviously, many modifications and variations can be made based on the contents of this specification. This description selects and specifically describes these embodiments in order to better explain the principles and practical applications of the present application, so that those skilled in the art can well understand and use the present application. This application is to be limited only by the claims, along with their full scope and equivalents.

1. A drawer guide rail with interlocking function comprising a cabinet (1), at least three drawers (2) distributed up and down on the cabinet (1), and a guide rail assembly (3) provided on an outer wall of each said drawer (2), wherein the guide rail assembly (3) comprises an inner rail (301) that drives the drawer (2) to slide, an outer rail (302) fixed on the cabinet (1), and a middle rail (303) connecting the inner rail (301) and the outer rail (302), wherein the guide rail assembly (3) is provided with an interlocking component with an interlocking function;
the interlocking component comprises a fixing mechanism (4) fixed on the outer rail (302), a toggle mechanism (7) fixed on the inner rail (301), and at least one upper and lower interlocking linkage members inserted at one end of the fixing mechanism (4);
a sliding mechanism (5) is slidably connected on a surface of the fixing mechanism (4), and a transmission mechanism (6) is arranged between the sliding mechanism (5) and the fixing mechanism (4), and the transmission mechanism (6) is movably connected with the sliding mechanism (5) and the fixing mechanism (4) on both sides, and the transmission mechanism (6) is configured to slide on the fixing mechanism (4) and the sliding mechanism (5);
the interlocking linkage member comprises a connecting rod (9) and a plugging mechanism (8) arranged at both ends of the connecting rod (9), and the plugging mechanism (8) is configured to plug a top part or bottom part at one end of the fixing mechanism (4);
wherein a reinforcement rod (703) is provided on a surface of the toggling plate (701), wherein the reinforcement rod is located on the side where the third sliding groove (702) is located, and the reinforcement rod (703) is configured to strengthen a structural strength at the third sliding groove (702) on the toggling plate (701).

2. The drawer guide rail with interlocking function according to claim 1, wherein the fixing mechanism (4) comprises a fixing seat (401) fixed on the outer rail (302), a surface of the fixing seat (401) is provided with a first sliding groove (402), and a ferrule (403) for insertion by the plugging mechanism (8) is fixedly arranged on a top part and bottom part on the surface of the fixing seat (401).

3. The drawer guide rail with interlocking function according to claim 2, wherein the sliding mechanism (5) comprises a sliding plate (501) slidably installed on the fixed seat (401), a surface of the sliding plate (501) is provided with a shaft hole (502) and a second sliding groove (503), and the shaft hole (502) is located near the second sliding groove (503).

4. The drawer guide rail with interlocking function according to claim 3, wherein the transmission mechanism (6) comprises a movable block (601), a top part of an outer wall surface of the movable block (601) is provided with a shaft (602) for inserting into the shaft hole (502), and a bottom part of the outer wall surface of the movable block (601) is provided with a synchronous rod (603), and one end of the synchronous rod (603) is slidably connected to an inner cavity of the first sliding groove (402), and the other end is movably connected to the second sliding groove (503).

5. The drawer guide rail with interlocking function according to claim 4, wherein the toggle mechanism (7) comprises a toggling plate (701) fixed on an inner wall of the inner rail (301), a third sliding groove (702) is provided on a surface of the toggling plate (701), and one end of the third sliding groove (702) is in an open shape, and the third sliding groove (702) is configured to movably engage the synchronous rod (603).

6. The drawer guide rail with interlocking function according to claim 1, wherein the plugging mechanism (8) comprises a latch plate (801) fixed on the connecting rod (9), the other end of the latch plate (801) is provided with a pull hook (802), and a blocking frame (803) for blocking the movement of the sliding mechanism (5) is arranged in the middle of a surface of the latch plate (801).

7. The drawer guide rail with interlocking function according to claim 2, wherein the fixing seat (401) is fixedly connected with the outer rail (302) through first rivets (10) on both sides.

8. The drawer guide rail with interlocking function according to claim 2, wherein a buffer elastic pieces (404) are fixedly arranged at the upper and lower positions of one end of the fixing seat (401), and the upper and lower positions are located on the side where the ferrule is located, wherein the buffer elastic piece (404) is configured to reduce the impact of the middle rail (303) on the fixing seat (401).

9. (canceled)

10. The drawer guide rail with interlocking function according to claim 5, wherein the toggling plate (701) is fixedly connected with the inner wall of the inner rail (301) through second rivets (11).
